(19) United States
(12) Patent Application Publication
(10) Pub. No.: US 2025/0010287 A1
(43) Pub. Date: Jan. 9, 2025

(54) INTEGRATED MICROFLUIDIC CHIP FOR CELL IMAGING AND BIOCHEMICAL DETECTION AND METHOD USING THE SAME

(71) Applicant: NATIONAL CENTRAL UNIVERSITY, Taoyuan City (TW)

(72) Inventors: CHEN HAN HUANG, Taoyuan City (TW); CHUN SAN TAI, Taoyuan City (TW); TING YI LIN, Taoyuan City (TW)

(73) Assignee: NATIONAL CENTRAL UNIVERSITY, Taoyuan City (TW)

(21) Appl. No.: 18/893,264

(22) Filed: Sep. 23, 2024

Related U.S. Application Data
(63) Continuation-in-part of application No. 17/543,728, filed on Dec. 6, 2021.

(51) Int. Cl. B01L 3/00

(52) U.S. Cl. CPC B01L 3/502707; B01L 2200/026; B01L 2200/14; B01L 2300/0636; B01L 2300/0681; B01L 2300/0887

(57) ABSTRACT

An integrated chip having an integrated function capable of providing cell image and biochemical detection is provided and includes a sequentially stacked and sealed laminate set. The laminate set includes an upper laminate, a middle laminate and a lower laminate. The upper laminate has one or more holes for sample injection and sample or air discharging of. The middle laminate includes at least two hollow structures that define an imaging chamber and a biochemical detection area. The lower laminate includes at least one filtering element and at least one electrode sensing element disposed in the biochemical detection. The filtering element is for blocking suspended particles, and the electrode sensing element has electrode terminals for connecting to instruments or equipment to perform the measurements and analysis of electrochemistry and impedance.

### BACKGROUND OF THE INVENTION

### 1. Field of the Invention

The present invention relates to an integrated chip that has an integrated function capable of providing cell image and biochemical detection, and more particularly relates to a microfluidic biological detection chip that includes a cell fluid chamber and an electrochemistry detection area.

### 2. Description of Related Art

Biochemical characteristic analysis and the image for a specific cell is generally applied in biomedical detection and can provide qualitative and quantitative research for cell and molecule target and medical efficacy evaluation related, etc.

A microfluidic chip can be used for detecting microparticles, such as cells, genetic materials, and proteins, etc., and has been utilized in the fields such as chemical analysis, biomedicine, and environmental monitoring, etc. In the testing process, a sample with microparticles in microfluidic channels needs to be steadily positioned on the center to increase the accuracy of the detection. In general, the positioning manner includes hydrodynamic positioning and acoustic positioning, etc.

However, the conventional chips for biological detection rarely have an integrated function capable of providing image analysis and biological detection simultaneously. Therefore, the present invention provides an integrated chip with cellular molecule imaging and biological detection by utilizing the design of functional microfluidic channels. The chip includes a cell liquid chamber for air releasing and electrodes for electrochemistry detection section. The chamber can provide the storage of a sampled fluid biopsy and the usage of image capturing. The electrode portions in the electrochemistry detection section can sense the bio-electrochemical signals, so the multi-functional microfluidic channels of the chip can be utilized to provide image detection and biochemistry related detection simultaneously.

### SUMMARY OF THE INVENTION

In one aspect, the present invention relates to an integrated chip for providing cell image and biochemical detection including a sequentially stacked and sealed laminate set. The laminate set includes an upper laminate, a middle laminate and a lower laminate. The first laminate is formed of a first plate, which is having one or more holes penetrating the upper laminate, the holes used for sample injection, and sample or air discharging, respectively. The middle laminate is formed of a second plate, which is including at least two hollow structures that define an imaging chamber and a biochemical detection area, respectively. The lower laminate is formed of a third plate, which is including at least one set of a filtering element and electrode sensing element that is disposed in the biochemical detection. The filtering element is for blocking suspended particles, and the electrode sensing element has an electrode section and electrode terminals that can provide connection to instruments or equipment to perform the measurements and analysis of electrochemistry and impedance.

The integrated chip of the present invention can detect the morphology of a cell and the microparticles contained therein (a specific genetic material, protein, etc.) simultaneously. The detection manners generally include the method such as electrical impedance detection, fluorescence detection, light scattering, microscopic imaging, etc.

In the preferred embodiment of the present invention, the plates of the laminate set can be made of the materials selected from light penetrable (preferably transparent) glass, plastic, acrylic, etc., and the thickness of each plate is between 50-300 micrometers.

In the preferred embodiment of the present invention, the imaging chamber can be connected to an image monitoring device that includes a microscopic image receiver and an image analysis device.

In the preferred embodiment of the present invention, the electrode sensing element includes at least a pair of microelectrodes on which electrical signals with different amplitudes and frequencies are applied (e.q., cyclic voltammetry (CV) method, the chronoamperometry method, etc.) to perform the measurements of electrochemistry.

In the preferred embodiment of the present invention, a molecule for capturing, e.q., biomolecules such as an antibody, antigen, nucleic acid, protein, etc., is modified in the electrode section to allow a target molecule present in a sample to be bound with the molecule for capturing. The electrochemical measurements for the target molecule captured on the chip can be performed using the electrochemical characteristics of the target molecule. Alternatively, a corresponding molecule carrying a detectable material, e.q., biomolecules such as an antibody, antigen, nucleic acid, protein, etc. is further introduced and bound again to perform the electrochemical measurements and analysis of the corresponding molecule via the electrode terminals.

In another aspect, the present invention relates to an image monitoring device, which comprises the integrated microfluidic chip for cell imaging and biochemical detection mentioned above, a microscopic image receiver, and an image analysis device. The imaging chamber is further connected to the image monitoring device. A microscopic image receiver is used as part of the system to receive and process images.

### BRIEF DESCRIPTION OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is a structural illustration of an integrated microfluidic chip for cell imaging and biochemical detection according to embodiment 1 of the present invention.

FIG. 2 is a top view photo of an integrated microfluidic chip 100 for cell imaging and biochemical detection. The chip has empty slots for capturing cell or particle image and for performing electrochemical detection, i.e., an imaging chamber 1051 and a biochemical detection area 1061, respectively.

FIG. 3 is an exemplary figure of filtering elements of the integrated microfluidic chip for cell imaging and biochemical detection according to the present invention. The filtering elements can include a filtering area composed of one or more microarrays in the form of a pillar (a), fence (b), or sieve (c).

FIG. 4 is an illustration of modifications and detection being performed on the electrode sensing element of the integrated microfluidic chip for cell imaging and biochemical detection according to the present invention. FIG. 4(a) is an illustration of a molecule for capturing (e.q., an antibody) being modified first on the electrode sensing element; FIG. 4 (b) is an illustration of a target molecule (e.q., an antigen) being bound with the molecule for capturing; 4(c) is an illustration of a molecular (e.q., a secondary antibody) carrying a detectable material being bound with the captured target molecule; and FIG. 4(d) is an illustration of electrochemical measurements and analysis being performed, on an electrode section of the sensing element, for the detectable material using its electrochemical characteristics.

FIG. 5 are the imaging results of blood cells (A) and nerve cells (B). Samples are injected into the chips of the present invention in which the cells are dispersed in an imaging chamber of the chips, and images of the chips are then captured in a microscope system.

FIG. 6 is a result of performing electrochemical measurement for the chip of the present invention. The solution of potassium hexacyanoferrate (III) is introduced into the chip, and the measurement is performed utilizing the cyclic voltammetry (CV) method in electrochemistry via the electrode terminals of the chip that are connected to an electrochemical sensing instrument.

FIG. 7 is a result of performing electrochemical measurement for the chip of the present invention. A different concentration of protein kinase (AKT1) is introduced into the chip, and the measurement is performed utilizing the chronoamperometry method in electrochemistry via the electrode terminals of the chip that are connected to an electrochemical sensing instrument.

### DETAILED DESCRIPTION OF THE PREFERRED EMBODIMENT

These and other aspects of the embodiments herein will be better appreciated and understood when considered in conjunction with the following description and the accompanying drawings.

The embodiments below are used to illustrate the present invention and are not considered as a limitation to the scope of the present invention. Unless specifically designated, the techniques used in the embodiments are ordinary skills known to the skilled in the art, and all materials are commercially available.

### Embodiment 1: Integrated Microfluidic Chip for Cell Imaging and Biochemical Detection

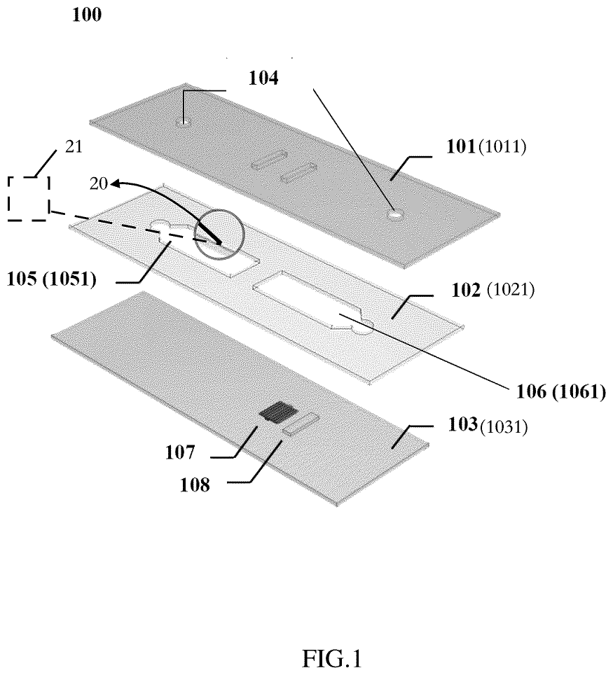

Referring to FIG. 1, an integrated microfluidic chip 100 for cell imaging and biochemical detection provided by this embodiment is composed of several laminates: an upper laminate 101, a middle laminate 102 and a lower laminate 103. The upper laminate 101 is formed of a first plate 1011, and has at least two hollow structures penetrating the upper laminate 101. In this embodiment, the two hollow structures are preferably two holes 104 with a diameter between 3-10 millimeters that are used for sample injection and the sample or air releasing, respectively. The middle laminate 102 is formed of a second plate 1021, and has two hollow structures 105 and 106. When the middle laminate 102 is combined with the upper laminate 101 and a lower laminate 103, an imaging chamber 1051 with slot-like shape and biochemical detection area 1061 are formed, respectively. The imaging chamber 1051 can contain and store an added liquid sample or culture medium for cell image capturing and analyzing. The lower laminate 103 is formed of a third plate 1031 and provided with one or more filtering elements 108 and electrode sensing elements 107 that correspond to the location of the biochemical detection area 1061. The filtering element 108 is used to block suspended particles. The electrode sensing element 107 includes an electrode section and electrode terminals. The structure of the electrode section can be electrochemical structure in an X shape, dotted shape, patterns, etc. The electrode terminals can provide instruments or equipment connection in order to perform the measurements and analysis of electrochemistry and impedance.

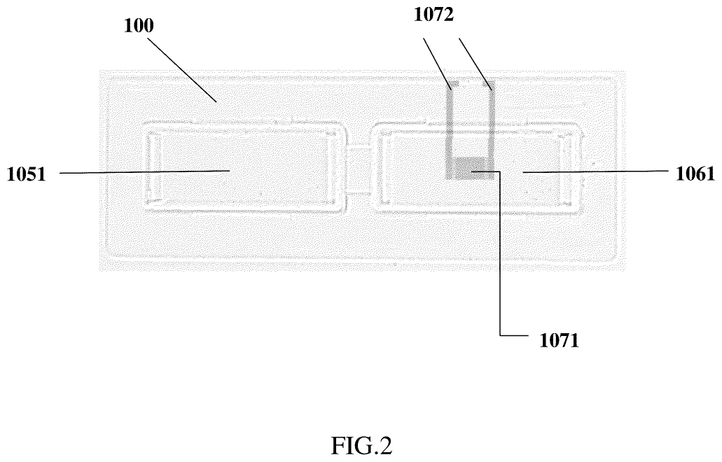

FIG. 2 is a top view photo of the integrated microfluidic chip 100 for cell imaging and biochemical detection. Because the upper laminate 101 is made of a transparent material, the chip 100 can be seen in this photo having two empty slots defined by the hollow structures 105 and 106 to be the imaging chamber 1051 and the biochemical detection area 1061, respectively. In the biochemical detection area 1061, the electrode sensing element 107 disposed on the lower laminate 103 can be seen. The electrode sensing element 107 has the electrode section 1071 and the electrode terminals 1072 to provide instrument or equipment connection so as to perform the measurements and analysis of electrochemistry and impedance.

As shown in FIG. 2, the connection between the electrode section 1071 and the electrode terminals 1072 is typically such that the electrode terminals 1072 are positioned on both sides of the electrode section 1071, with part of them located within the biochemical detection area 1061. This configuration ensures the successful execution of electrochemical measurements because the electrode terminals 1072 can connect with instruments or devices for current input and for conducting electrochemical and impedance measurement analyses.

As for the shape, size, material properties, and layout of the electrodes, the document does not provide specific details. However, based on the available content, it can be inferred that the electrode design should be capable of performing electrochemical measurements, such as cyclic voltammetry (CV) and chronoamperometry. This likely implies that the electrodes have an appropriate surface area and conductivity to ensure effective electrochemical reactions and signal detection. The material properties may include the use of highly conductive materials, such as gold, platinum, or carbon-based materials. In terms of layout, the electrodes might be designed to be compatible with the filtering structure 108 and microarrays 109, allowing for immediate analysis of samples after filtration. The specific size and shape would depend on the desired electrochemical performance and integration with other microfluidic structures.

Therefore, after filtration, the sample can undergo electrochemical analysis immediately, significantly reducing the risk of inaccuracies in the analysis results caused by impurities affecting the sample within the flow channel. By minimizing the distance and time between filtration and detection, the system can effectively reduce contamination and external interference, thereby enhancing the accuracy and reliability of the measurements.

The shape and size of the electrode section 1071 can affect the power density and energy density. For example, porous electrodes can increase the surface area of the electrode section 1071, thereby enhancing the charge and discharge rates. The choice of electrode materials is crucial for the performance. Materials with good conductivity can reduce internal resistance losses and improve energy conversion efficiency. Additionally, the stability and durability of the materials also impact the lifespan and safety of the electrode sensing element 107. The layout design of the electrode section 1071 affects the internal electron and ion transport within the electrode sensing element 107. An optimized layout can reduce transport distances, improving the reaction rate and efficiency.

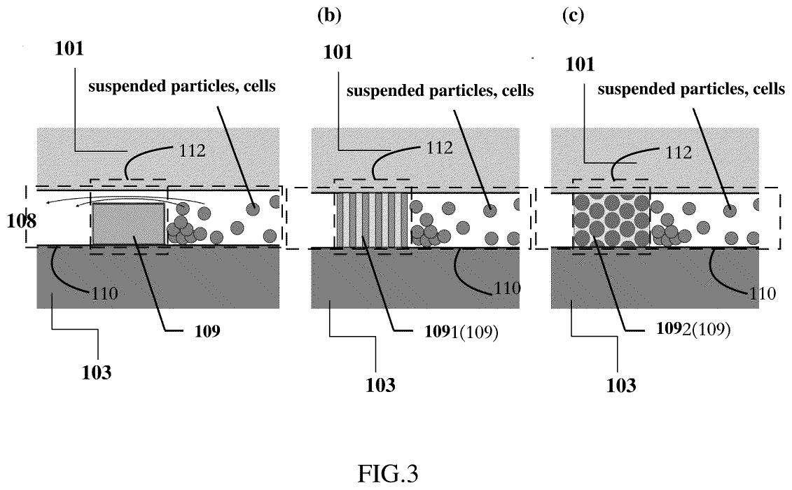

FIG. 3 is the exemplary illustration of the filtering element 108 that the filtering element 108 is a filtering area 112 constructed by one or more microarrays 109 in the form of a slot or pillar (a), fence (b), or sieve (c). The filtering area 112 is mainly used to filter suspended particles (including macromolecules, cells, etc.), which allows the micromolecules in a sample to pass through the filtering element and move into the electrode sensing element 107 where biochemical measurements are performed.

As shown in FIG. 3, the microarrays 109 are composed of a plurality of micro pillars 1091 or microbeads 1092. The micro pillars 1091 are usually elongated columnar structures that can be cylindrical or have other cross-sectional shapes, with diameters and heights in the micrometer range. Micro pillars 1091 can be arranged in regular or irregular patterns, depending on their application. They are typically fixed structures integrated onto a substrate, with diverse designs that can be combined with microfluidic devices to precisely control fluid flow and sample handling.

The microbeads 1092 are typically small, spherical particles ranging in size from a few micrometers to several hundred micrometers. Their spherical shape allows them to flow well and distribute evenly in fluids. Structurally, the microbeads 1092 are usually independent particles, easily modified on their surfaces to achieve specific functions. They can be solid or hollow and made from a variety of materials, such as polymers, glass, or magnetic substances, but is not limited thereto.

In the integrated chip of the present invention, the imaging chamber 1051 and biochemical detection area 1061 defined by the hollow structures 105 and 106, respectively, can be intercommunicated with each other or be independent. In the design of being intercommunicated with each other, one or more connecting channels 110 are disposed between the imaging chamber 1051 and the biochemical detection area 1061. A filtering element, which is the same as or similar with the aforementioned filtering element, can be disposed in the connecting channels 110 and has a filtering area 112 constructed by one or more microarrays in the form of a pillar, slot, or fence. The image of cells and micromolecules moving into the imaging chamber 1051 can be captured by a variety of image capturing devices or microscope imaging systems. The captured image can be further recorded and analyzed after being transmitted to an image analyzing equipment by a receiver.

Electrode sensing element 107, used to perform biochemical and electrical operations or analysis, includes dielectrophoresis control, impedance analysis, and electrochemical measurements, etc. Modifications can be done in the electrode sensing element 107 to assist the detection of biochemical specificity. For example, a molecule for capturing (e.q., the biomolecules such as an antibody, antigen, nucleic acid, protein, etc.) can be modified on the electrode sensing element 107. A target molecule will be bound with the capture molecule when the target to be detected passes through, then the electrochemical measurements for the target molecule can be performed using its electrochemical characteristics. Alternatively, a corresponding detected molecule (e.q., a biomolecule such as an antibody, antigen, nucleic acid, protein, etc., which carries a detectable material) is further introduced and bound with the target molecule captured on the electrode sensing element 107 to perform the electrochemical measurements and analysis for the detected molecule in the electrode section 1071 in accordance with the electrochemical characteristics of the detected molecule.

### Embodiment 2: the Using Method of the Integrated Microfluidic Chip for Cell Imaging and Biochemical Detection

A sample to be tested, which may be a liquid sample or cell culture retrieved from a patient, is injected into the hole 104 defined by the upper laminate 101 of the chip 100. The liquid sample flows into the imaging chamber 1051 and biochemical detection area 1061 that are defined by the hollow structures 105 and 106 of the middle laminate 102, respectively, via microfluidic channels.

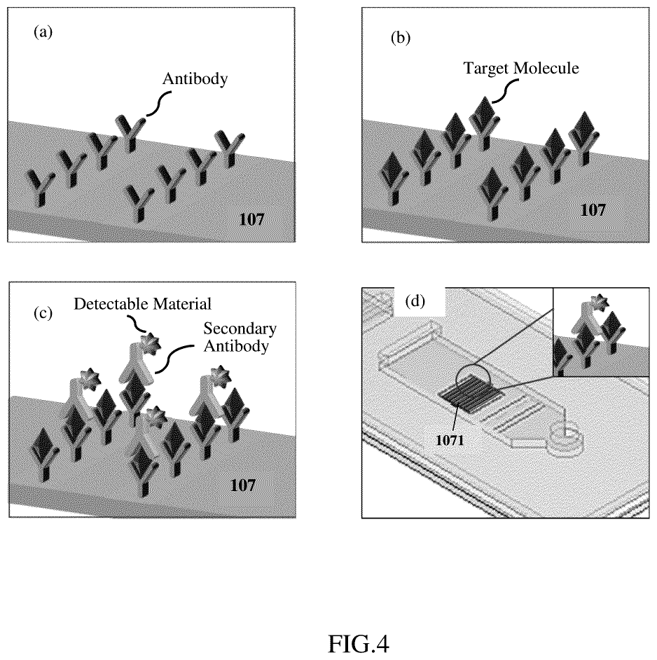

FIG. 4 is an illustration view of an antibody modification and a target molecule detection in the electrode sensing element 107. The embodiment uses an antigen existed in a sample to be tested as the target molecule. As shown in FIG. 4(a), a capture molecule for capturing the specific antigen (e.q., an antibody against the target antigen) is modified first on the electrode sensing element 107. After the fluid sample to be tested is filtered, the target antigen contained in the filtered fluid will be bound with the target molecule on the electrode sensing element 107 (FIG. 4(b)). A corresponding detected molecule (e.q., a secondary antibody carrying a detectable material) is further introduced and bound with the captured target molecule (FIG. 4(c)), so as to perform the electrochemical measurements and analysis for the corresponding detected molecule in the electrode section 1071 of the sensing element 107 (FIG. 4(d)) in accordance with the electrochemical characteristics of the detected molecule.

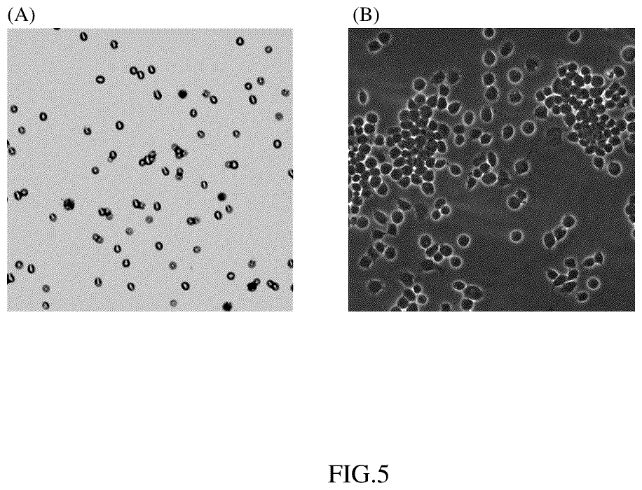

The image of cells in the fluid sample that flows into the imaging chamber 1051 defined by the hollow structure 105 can be captured by a variety of image capturing devices or microscope imaging systems. The image of cells can be analyzed by a microscopic image analysis and interpretation system to determine morphology and pathological conditions of the specific cell. FIG. 5 is a photomicrograph of blood cells (A) and nerve cells (B), which are results that blood and cell culture medium are injected, respectively, into chips. Thereafter, the cells are dispersed in the chamber of the chips, and the chips are then placed in a microscope system for image capturing.

When the fluid sample flowing into the biochemical detection area 1061 passes through the microarray area of the filtering element 108 disposed on the lower laminate 103, the suspended particles (including macromolecules, cells, or debris thereof, etc.) in the fluid sample can be blocked outside the filtering microarrays 109 because of the filtering microarrays 109 in the form of a pillar, slot, fence, or sieve. Accordingly, only the micromolecules in the sample are allowed to pass through the filtering element 108 and move into the electrode sensing element 107 for electrochemical measurements.

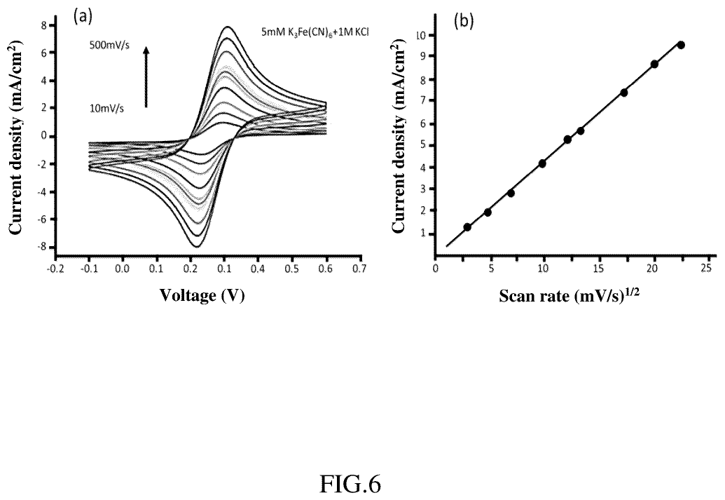

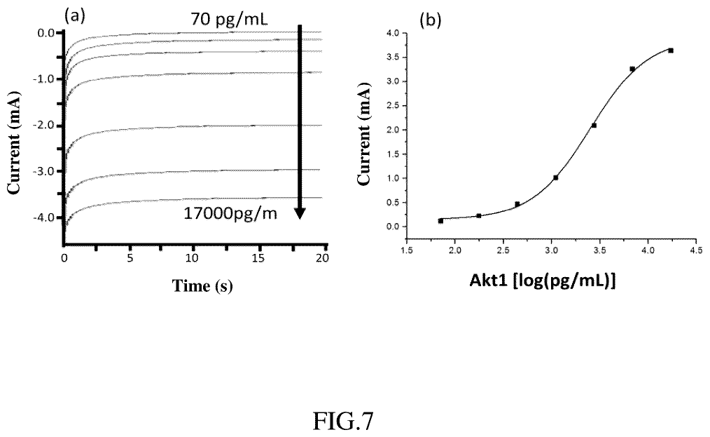

FIG. 6 is a result of the electrochemical measurement of the fluid sample passing through the filtering element 108. The electrochemical measurement is performed in the biochemical detection area 1061 where the solution of potassium hexacyanoferrate (III) is introduced into the chip. The measurement is performed by utilizing the cyclic voltammetry (CV) method in electrochemistry when the electrode terminals 1072 of the chip are connected to an electrochemical sensing instrument. FIG. 7 is a result of the electrochemical measurement of the fluid sample passing through the filtering element 108. The electrochemical measurement is performed in the biochemical detection area 1061 where a different concentration of protein kinase (AKT1) is introduced into the chip, and the measurement is performed by utilizing the chronoamperometry method in electrochemistry when the electrode terminals 1072 of the chip are connected to an electrochemical sensing instrument.

One embodiment of the present invention is directed to an image monitoring device, which comprises the integrated microfluidic chip for cell imaging and biochemical detection mentioned above, a microscopic image receiver 20, and an image analysis device 21. The imaging chamber 1051 is further connected to the image monitoring device. A microscopic image receiver 20 is used as part of the system to receive and process images.

The image analysis device 21 should be positioned to receive image signals from the microscopic image receiver 20. This means it should be directly connected to the microscopic image receiver 20 or linked via data transmission lines (such as USB, Ethernet, or wireless connections) to receive and process these images. In practical implementations, the image analysis device 21 may be a dedicated computer system equipped with a powerful processor and specialized analysis software for detailed examination of the received images.

The primary function of the microscopic image receiver 20 is to receive microscopic images from the imaging chamber 1051 and transmit these images to image analysis equipment for recording and analysis. During the image acquisition process, the microscopic image receiver 20 connects to various image capture devices or microscope imaging systems. When a liquid sample enters the imaging chamber 1051, images of the cells or particles within the sample are captured by these devices.

The microscopic image receiver 20 can be a photosensitive element or a camera, but is not limited thereto. The microscopic image receiver 20 is used to receive optical signals and convert them into digital signals for further processing and analysis. In an implementation example, a microscope imaging system is used for image acquisition, and the microscopic image receiver 20 is compatible with the image analysis device 21, enabling it to receive and process magnified images.

The image analysis device 21 included in the image monitoring device is designed to handle a variety of biochemical assays. This device can process data from different biochemical reactions, including enzyme reactions and molecular marker assays. The image analysis device 21 is equipped with advanced algorithms and software that allow it to analyze these results comprehensively. It integrates data from multiple sources, providing a unified analysis of biochemical reactions. This capability enables users to obtain a holistic view of the biochemical processes occurring within the imaging chamber 1051, improving the accuracy and relevance of the assay results.

The microscopic image receiver 20 in the image monitoring device is designed to work in conjunction with micro sensors embedded in the integrated microfluidic chip. This synchronization allows for real-time monitoring of biochemical reactions occurring on the chip. By coordinating with the micro sensors, the image receiver captures images that reflect the current state of biochemical processes, providing immediate feedback on reaction dynamics. This real-time capability is crucial for observing transient or rapid biochemical events, ensuring timely and accurate data collection for subsequent analysis.

In one embodiment, the image monitoring device is equipped with an adaptive control system that monitors cell images and automatically adjusts the parameters of the integrated microfluidic chip. As the cell images are analyzed, the device can detect changes or variations in the cellular environment or biochemical processes. Based on this real-time analysis, the device adjusts parameters such as fluid flow rates, reagent concentrations, or imaging settings to optimize the conditions for cell imaging and biochemical detection. This dynamic adjustment capability enhances the accuracy and sensitivity of the assays by ensuring that the chip operates under optimal conditions throughout the experiment.

As shown in FIG. 1, the microscopic image receiver 20 should be positioned in a location capable of receiving microscopic images from the imaging chamber 1051, but not limited to this position. Specifically, it should be connected to the imaging chamber 1051 to capture images of cells or particles within the imaging chamber 1051. The received images are then transmitted to the image analysis device 21 for recording and analysis. This may be above or to the side of the imaging chamber 1051, depending on the design of the imaging system and the path of the optical path. In practical implementations, the microscopic image receiver 20 may be a photosensitive element or a camera, connected to the microscopy system to ensure clear capture of images of cells or particles.

The preferred embodiments above are merely exemplary, the present invention may include various embodiments described in this description and other embodiments. Further, the above-mentioned embodiments are merely illustrations of the present invention and are not limiting. Other equivalent variations and modifications done without departing the spirit disclosed by the present invention shall be included in the claims described below.

While the present invention has been described in terms of what are presently considered to be the most practical and preferred embodiments, it is to be understood that the present invention need not be restricted to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

What is claimed is:

1. An integrated microfluidic chip for cell imaging and biochemical detection including a sequentially stacked and sealed laminate set, the laminate set comprising:
an upper laminate formed of a first plate, having at least one hole for sample injection and sample or air discharging;
a middle laminate formed of a second plate, including at least two hollow structures penetrating the middle laminate that defining an imaging chamber and a biochemical detection area, respectively; and
a lower laminate formed of a third plate, including at least one filtering element and at least one electrode sensing element that are disposed on the third plate and corresponding to the biochemical detection area,
wherein the at least one filtering element includes a filtering area composed of one or more microarrays, and the at least one electrode sensing element includes an electrode section and an electrode terminal for connecting to devices, the microarrays and the electrode sensing element are both positioned within the biochemical detection area, for inputting current and measuring and analyzing electrochemistry and impedance;
wherein the one or more microarrays are composed of a plurality of micro pillars or microbeads arranged in form of pillar, slot or fence.

2. The integrated microfluidic chip for cell imaging and biochemical detection of claim 1, wherein the first plate, the second plate, and the third plate of the laminate set is made of a material selected from the group consisting of light penetrable glass, plastic, and acrylic, and the thickness of each plate is between 50-300 micrometers.

3. The integrated microfluidic chip for cell imaging and biochemical detection of claim 1, further comprising at least one connecting channel,
wherein the at least one connecting channel is disposed between the imaging chamber and the biochemical detection area, and the filtering element includes a filtering area composed of at least one microarray disposed in one of the at least one connecting channel.

4. The integrated microfluidic chip for cell imaging and biochemical detection of claim 1, where the electrode section includes a molecule for capturing that has been modified such that it can be bound with a target molecule.

5. The integrated microfluidic chip for cell imaging and biochemical detection of claim 4, wherein the molecule for capturing is an antibody, antigen, nucleic acid or protein.

6. An image monitoring device, comprising:
the integrated microfluidic chip for cell imaging and biochemical detection as claimed in claim 1;
a microscopic image receiver; and
an image analysis device;
wherein the imaging chamber is further connected to the image monitoring device, and the microscopic image receiver is compatible with the image analysis device.

7. The image monitoring device of claim 6, wherein the microscopic image receiver may be a photosensitive element or a camera.

8. The image monitoring device of claim 6, wherein the image analysis device is capable of processing results from different types of biochemical assays, such as enzyme reactions or molecular markers, and performing integrated analysis.

9. The image monitoring device of claim 6, wherein the microscopic image receiver is capable of synchronizing with micro sensors on the integrated microfluidic chip for cell imaging and biochemical detection to monitor biochemical reactions in real-time.

10. The image monitoring device of claim 6, wherein the image analysis device is capable of automatically adjusting the parameters of the integrated microfluidic chip for cell imaging and biochemical detection based on changes in cell images.
